(19) United States
(12) Patent Application Publication
(10) Pub. No.: US 2014/0136518 A1
(43) Pub. Date: May 15, 2014

(54) MULTI-PANE PRESENTATION OF MULTIDIMENSIONAL SEARCH RESULTS

(71) Applicant: MICROSOFT CORPORATION, Redmond, WA (US)

(72) Inventors: Heung Yeung Shum, Medina, WA (US); Derrick Leslie Connell, Bellevue, WA (US)

(73) Assignee: MICROSOFT CORPORATION, Redmond, WA (US)

(21) Appl. No.: 13/674,915

(22) Filed: Nov. 12, 2012

(51) Int. Cl. G06F 17/30

(52) U.S. Cl. 707/722; 707/E17.014

(57) ABSTRACT

A user is provided with multidimensional search results in multiple panes. Search results include, not only content, typically documents, responsive to a user's search query, but also include information regarding entities that are responsive to the search query, including tasks relevant to those entities, and include identifications of individuals from whom additional information can be obtained, or who are otherwise relevant to the user's search. Responsive documents are presented in one pane, while responsive entities and associated information and tasks are presented in a separate pane and responsive individuals are presented in yet another separate pane. Two or more panes can be presented to the user, and user action in one pane can impact other panes, such as user selections in the entity pane being utilized to disambiguate the search query and thereby causing the listing of documents presented in another pane to be updated in accordance with the disambiguation.

### BACKGROUND

As network communications among multiple computing devices have become ubiquitous, the quantity of information available via such network communications has increased exponentially. For example, the ubiquitous Internet and World Wide Web comprise information sourced by a vast array of entities throughout the world, including corporations, universities, individuals and the like. Such information is often marked, or “tagged”, in such a manner that it can be found, identified and indexed by services known as “search engines”. Even information that is not optimized for search engine indexing can still be located by services, associated with search engines, which seek out information available through network communications with other computing devices and enable a search engine to index such information for subsequent retrieval.

Due to the sheer volume of information available to computing devices through network communications with other computing devices, users increasingly turn to search engines to find the information they seek. Search engines typically enable users to search for any topic and receive, from this vast volume of information, identifications of specific content that is deemed to be responsive to, or associated with, the users' queries. To sort through the vast amounts of information that is available, and timely provide useful responses to users' queries, search engines employ a myriad of mechanisms to optimize the identification and retrieval of responsive and associated information.

Unfortunately, even with the aid of search engines, users are often overwhelmed by the sheer volume of information available. For example, typical topics searched for by users often result in millions of results that are identified by search engines. To cope with such information overload, empirical data suggests that users typically select one of the first ten results, as ordered by a search engine. If what the user is searching for is not among those first ten results, the user can become quickly frustrated with the search engine and can seek to utilize a different search engine. Consequently, the utility of a search engine to users can be in such a search engine's ability to guide the user to the content for which the user was searching as efficiently as possible.

### SUMMARY

In one embodiment, search results received from a search engine, in response to a search query entered by the user, can comprise identifications of discrete sets of content, typically in the form of documents, identifications of entities and associated information and tasks, and identifications of individuals from whom additional information can be obtained. Such multidimensional search results can enable a user to more efficiently identify that for which they are searching, or more efficiently perform a task that is the basis for their search.

In another embodiment, such search results can be presented to a user in a multi-pane format, where each pane uniquely comprises one of: a listing of documents, an identification of entities, or an identification of individuals. Multi-pane user interfaces can comprise two panes, such as a pane displaying a listing of documents and a pane displaying identification of entities or, alternatively, a pane displaying a listing of documents and a pane displaying identification of individuals. Multi-pane user interfaces can also comprise three panes, with a first pane displaying a listing of documents, a second pane displaying an identification of entities, and a third pane displaying identification of individuals.

In a further embodiment, user action directed to one pane can affect the results in that one pane, the results presented in other panes, or combinations thereof. Such user action can be utilized to disambiguate the search results, and one or more panes can be updated with updated search results based upon such a disambiguation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary network of computing devices exchanging communications for providing multidimensional search results;

FIG. 2 is a block diagram of an exemplary multi-pane user interface;

FIG. 3 is a block diagram of an exemplary user interface presenting multidimensional search results in multiple panes;

FIG. 4 is a block diagram of exemplary desktop and mobile user interfaces presenting multidimensional search results in multiple panes;

FIG. 5 is a block diagram of user disambiguation through an exemplary multi-pane user interface.

FIG. 6 is a flow diagram of an exemplary operation of computer-executable instructions for enabling user disambiguation of search results; and

FIG. 7 is a block diagram of an exemplary computing device.

### DETAILED DESCRIPTION

The following descriptions are directed to user interfaces and associated mechanisms through which a user can be provided with multidimensional search results in multiple panes. Search results can include, not only content, typically in the form of text and multimedia documents, that is responsive to a user's search query, but can also include information regarding entities that are responsive to the search query, including tasks relevant to those entities, and can include identifications of individuals from whom additional information can be obtained, or who are otherwise relevant to the user's search. Responsive documents can be presented in one pane, while responsive entities and associated information and tasks can be presented in a separate pane and responsive individuals can be presented in yet another separate pane. Two or more panes can be presented to the user, and user action in one pane can impact the search results presented in that pane, in another pane, or combinations thereof. Such user selections can be utilized to disambiguate an otherwise ambiguous search query and thereby causing the search results presented in one or more panes to be updated in accordance with such a disambiguation.

For purposes of illustration, the techniques described herein make reference to existing and known application user interface contexts, such as user interfaces typically presented by Web browsers. Also for purposes of illustration, the techniques described herein make reference to existing and known protocols and languages, such as the ubiquitous HyperText Transfer Protocol (HTTP) and the equally ubiquitous HyperText Markup Language (HTML). Such references, however, are strictly exemplary and are not intended to limit the mechanisms described to the specific examples provided. Indeed, the techniques described are applicable to any application user interface including, for example, lifestyle and/or entertainment applications, such as audio and/or video presentation applications and electronic book readers, and other content consuming and presentation applications.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

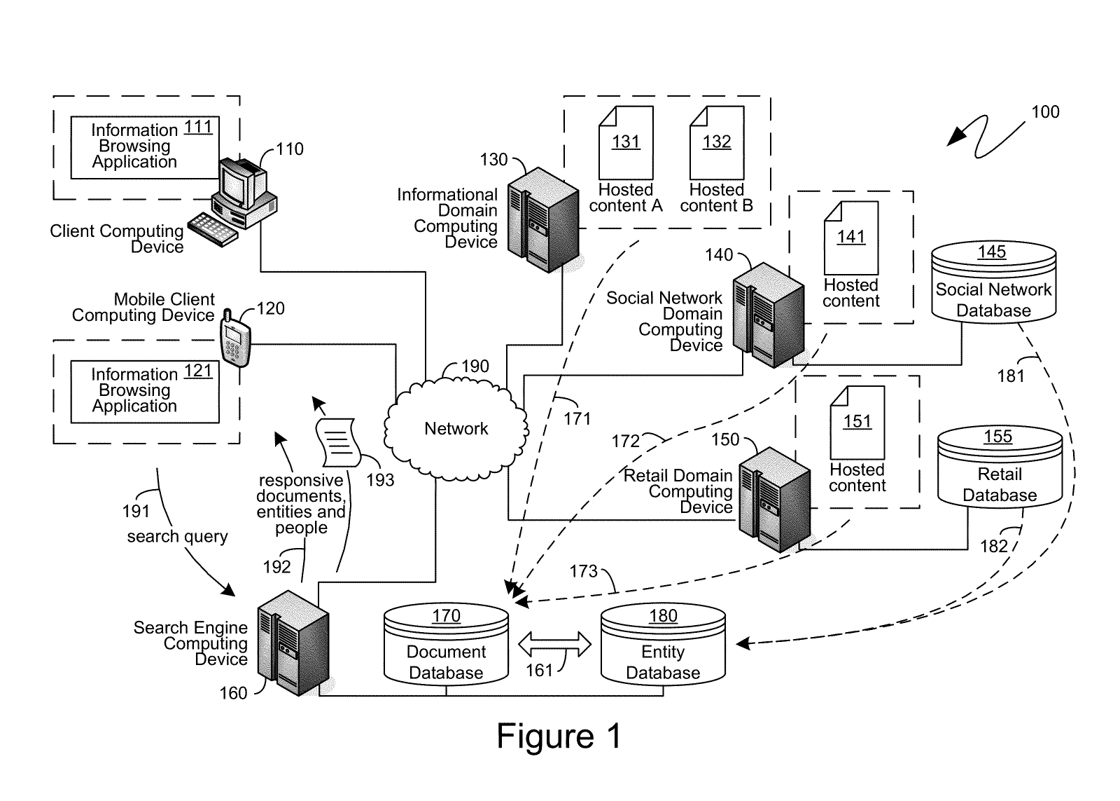

Turning to FIG. 1, an exemplary system 100 is shown, which provides context for the descriptions below. The exemplary system 100 of FIG. 1 is shown as comprising a traditional desktop client computing device 110, and a mobile client computing device 120 that are both communicationally coupled to a network 190. The network 190 also has, communicationally coupled to it, a search engine computing device 160 that can provide search functionality to users of client computing devices, such as the client computing device 110 or the mobile client computing device 120. The illustration of the search engine computing device 160 as a single device is strictly for illustrative simplicity, and the descriptions below are equally applicable to processes executing a single search engine computing device 160 or executing across multiple search engine computing devices, either in serial or in parallel.

The search engine computing device 160 can enable users of client computing devices to locate content accessible via the network 190. By way of example, an informational domain computing device 130, a social network domain computing device 140 and a retail domain computing device 150 are exemplarily shown as being communicationally coupled to the network 190 to provide context for the descriptions below. The informational domain computing device 130 can comprise hosted content 131 and 132. In one embodiment, the informational domain computing device 130 can be a traditional Web server computing device hosting one or more webpages, which typically provide informational content in the form of textual content, image content and other like hypermedia and multimedia content. The social network domain computing device 140 can comprise hosted content 141 that can be dynamically generated based upon information retrieved by the social network domain computing device 140 from the social network database 145 to which it is communicationally coupled. In one embodiment, the social network domain computing device 140 can be a computing device hosting a Web-based social network website through which users exchange textual messages, images, establish business connections, and perform other like social network functionality. In such an embodiment, the hosted content 141 can represent a dynamically generated webpage, such as a webpage on which users can post images or messages and have other users comment and leave feedback. The retail domain computing device 150 can comprise hosted content 151 that can be dynamically generated based upon information retrieved by the retail domain computing device 150 from the retail database 155 to which it is communicationally coupled. In one embodiment, the retail domain computing device 150 can be a computing device hosting a Web store or other like Web-based retail presence through which goods or services are sold. In such an embodiment, the hosted content 151 can represent a dynamically generated webpage, such as a webpage offering for sale a particular item and providing up-to-date information such as a current price of the item, whether or not the item is in stock, and other like information.

As will be recognized by those skilled in the art, in order to provide search functionality to users of client computing devices, the search engine computing device 160 can obtain information about the content available via the network 190, such as the content hosted by one or more of the computing devices 130, 140 and 150. For example, as illustrated by the arrows 171, 172 and 173, the search engine computing device 160 can be communicationally coupled to a document database 170 that can comprise information collected from the hosted content 131, 132, 141 and 151, respectively. Since such hosted content is typically divided into units, or “pages”, of information, such as the ubiquitous webpage, the database 170 is referred to as a document database even though the information contained therein is not retained in page format, but rather is organized in matrices to enable efficient searching thereof.

In one embodiment, in addition to the document database 170, the search engine computing device 160 can have access to an entity database 180. Such an entity database can comprise information about “entities”. An “entity”, as utilized herein, means any thing about which there is discrete, objective information available, such as can be determined by reference to a search engine database. By way of example, and not limitation, entities include individuals, organizations, places, products, activities, websites, entertainment offerings, and the like. The entity database 180 can be generated utilizing a variety of mechanisms. For example, in one embodiment, the entity database 180 can be generated by referencing the document database 170, the information of which can be utilized to identify those things that can be classified as “entities” based upon the availability of discrete, objective information thereof. Such an identification of entities, and such generation of information about such entities, from the document database 170 is illustratively represented by the arrow 161. In another embodiment, the entity database can be generated by collecting information from other databases such as the social network database 145 or the retail database 155. For example, the social network database 145 likely already comprises information divided into “entities” in the form of individual people, including, for example, names, birthdays and contact information. As another example, the retail database 155 likely already comprises information divided into “entities” in the form of individual retail goods including, for example, the name of a retail item, a unique identifier thereof, a current price, and certain relevant features thereof. Such information can be collected directly from such databases and utilized to populate the entity database 180. Additionally, the document database 170, social network databases, such as the social network database 145, and retail databases, such as the retail database 155, can augment information collected from one another. For example, entities in the entity database 180 can be created based on individuals identified in the social network database 145, but then such entities can have additional information associated with them based upon documents, relevant to the individuals of the social network database 145, that are part of the document database 170. In an analogous manner, as another example, entities in the entity database 180 created based upon information obtained from the document database 170 can have additional information associated with them based up the information stored in the retail database 155 or the social network database 145.

Both the client computing device 110 and the mobile client computing device 120 are shown as comprising information browsing applications 111 and 121 to illustrate that the mechanisms described below are equally applicable to mobile computing devices, including laptop computing devices, tablet computing devices, smartphone computing devices, and other like mobile computing devices, as well as to the ubiquitous desktop computing devices. For purposes of the descriptions below, references to the information browsing application 111 executing on the client computing device 110 are intended to be equally applicable to the information browsing application 121 executing on the mobile client computing device 120, and vice versa. In one embodiment, the information browsing application 111, or the information browsing application 121, can be the ubiquitous web browser that can retrieve and display information in the form of websites that are hosted by web servers communicationally coupled to the network 190, such as those described above. However, as indicated previously, the mechanisms described below are not limited to World Wide Web-based environments. Thus, for example, the information browsing applications 111 and 121, can be other types of information browsing applications including, for example, e-book readers, universal document format readers, or even content creation applications, such as word processors, spreadsheets, presentation applications, and e-mail applications. Yet another type of information browsing application can be an operating system itself, including, for example, operating systems comprising support for known networking protocols for the receipt and presentation of information and operating systems comprising information browsing components or built-in or included information browsing applications.

A user of the client computing device, such as the client computing device 110 or the mobile client computing device 120, can utilize the search functionality provided by the search engine computing device 160 by submitting a search query 191 to the search engine computing device 160. As will be recognized by those skilled in the art, such a search query can represent information, typically textual information, although it can include images, audio, and other like multimedia and hypermedia content, about which the user desires to obtain additional information from among the content available via the network 190. In response to the search query 191, in one embodiment, the search engine computing device 160 can provide “multidimensional search results”. As utilized herein the term “multidimensional search results” means search results that provide different types of information in response to a search query. For example, one dimension of search results can be the well-known identification of documents, or other like hosted content, that comprise content deemed relevant to the search query. Such identification of documents is typically in the form of web links and such documents are typically in the form of webpages. Another dimension of search results can be an identification of entities that are relevant to the search query, including information about such entities, and tasks and actions (referred to hereinafter as simply “tasks”) that can be associated with those entities such as, for example, reservation tasks that can be associated with hotel, restaurant, rental car, or other like entities, purchase tasks that can be associated with retail goods and services, and contact tasks that can be associated with individual people. Yet another dimension of search results can be an identification of people that are relevant to the search query, including information provided by such people via the network 190 such as, for example, textual information, images, blogs, or other like content authored by such people. In one embodiment, if a search query returns documents that are deemed to be responsive to such a query, then there can exist at least one person that can also be responsive to such a query, even if no entities are identified as being responsive to such a query.

The responsive documents, entities, people, and other like dimensions of search results can be provided in response to the search query, as illustrated by the communication 192. The descriptions below will be directed to the presentation of such multidimensional search results to a user of a client computing device such as, for example, client computing device 110 and the mobile client computer device 120. In addition, in one embodiment, a script 193, or other like collection of computer-executable instructions, can also be provided by the search engine computing device 160 to a client computing device in response to a search query received from such a client computing device. The script 193, as will be described in detail below, can collect information regarding user action directed to one dimension of search results to aid in the presentation of more relevant search results. For example, as will be described in further detail below, the search query 191 can be ambiguous in that two or more different entities can be equally relevant to the search query. As one specific example, a search query “Chicago” may be directed to the city in the state of Illinois, to a Broadway musical, or to a film from the year 2002. One dimension of search results can identify, to the user, each of these entities, while another dimension of search results can identify those documents having the term “Chicago” in them, or which are otherwise deemed relevant. User action directed to a specific entity such as, for example, user action directed to the film entity, can disambiguate the user's search query. Consequently, the documents deemed responsive to the search can be updated to focus on documents directed to the film “Chicago”. In such a manner, and as will be described in further detail below, user action directed to one-dimensional search results can increase the relevance the search results.

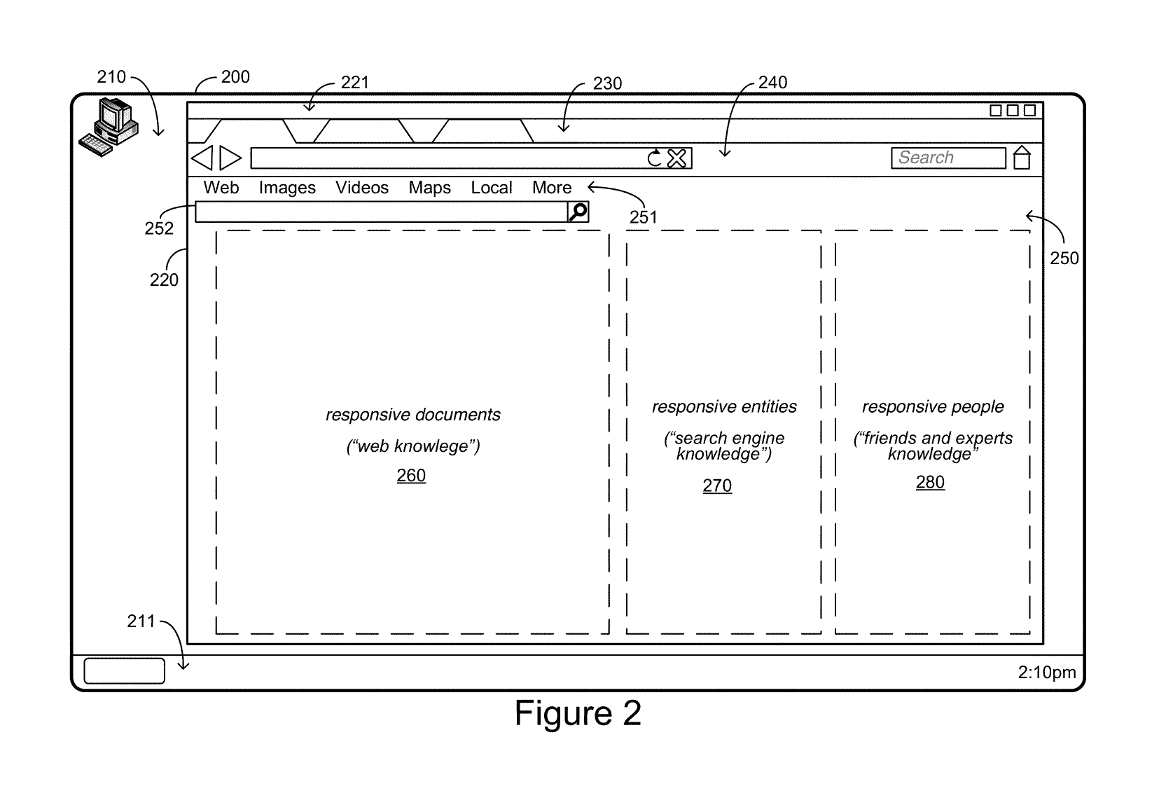

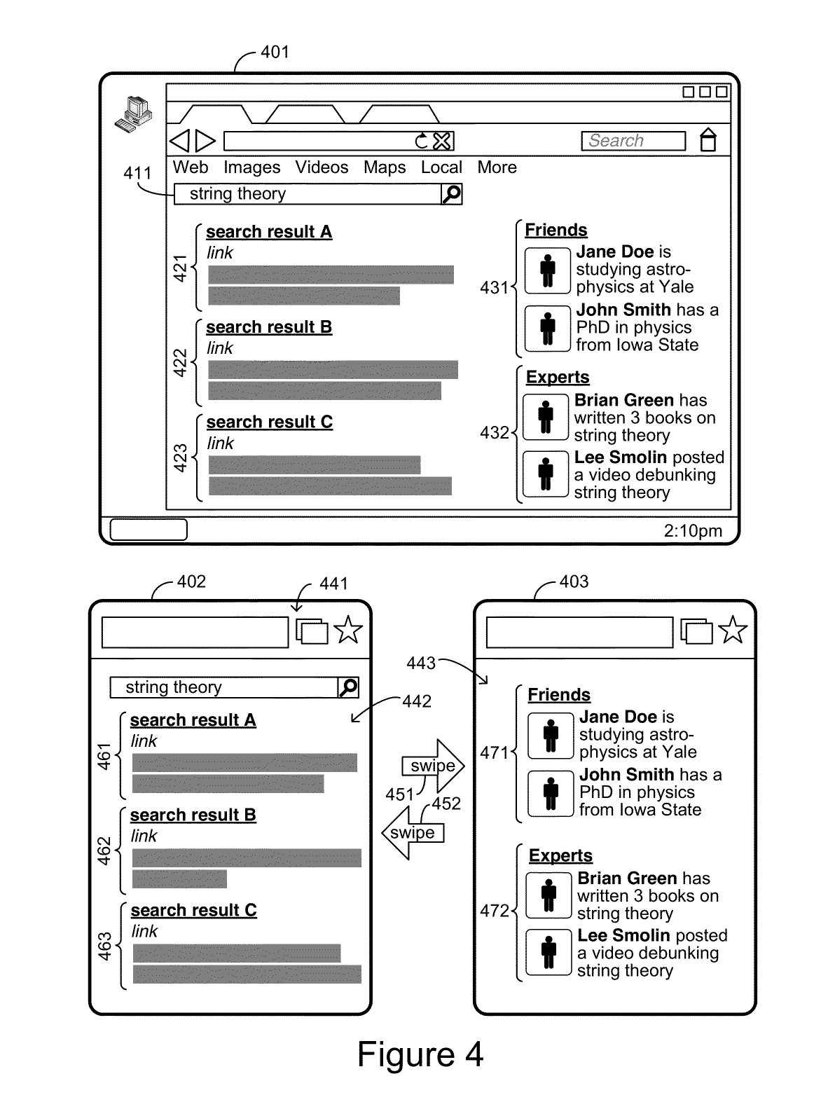

Turning to FIG. 2, an exemplary user interface 200 is illustrated comprising a multi-pane presentation of multidimensional search results. Although illustrated within the context of a sort of user interface that would typically be presented by a personal computing device, the descriptions provided below are equally applicable to the sort of user interfaces provided by mobile computing devices. Indeed, as will be described in further detail below, such as with reference to FIG. 4, the exemplary user interfaces described within the context of a “desktop” user interface motif, such as would typically be presented by personal computing devices, can be extended to the “screen” user interface motif, such as would typically be presented by mobile computing devices, in a straightforward manner that will be obvious to those skilled in the art.

Providing context for the descriptions below, the exemplary user interface 200 of FIG. 2 is shown as comprising a desktop 210 within which an application window 220 is presented. In conjunction with the desktop 210, the exemplary user interface 200 of FIG. 2 can also comprise a taskbar 211. The application window 220 can be presented by an information browsing application, such as those described in detail above, which can receive multidimensional search results in response to a user's search query. The application window 220 can comprise a window control area 221 with which the appearance of the window 220 within the user interface 200 can be controlled. Additionally, in one embodiment, the information browsing application can be capable of presenting multiple different sets of content within tabs, and such tabs can be accessed through a tab selection area 230.

User selection of content can, in one embodiment, be controlled through a toolbar area 240, which can comprise mechanisms by which users can directly specify content, such as through content resource locators or other like content identifiers, mechanisms by which users can browse through content that was previously viewed, and other like content control mechanisms. The content itself can be displayed in a content presentation area 250 which, in the exemplary user interface 200 is illustrated in FIG. 2, can comprise content received from a search engine that is capable of providing multidimensional search results. In particular, a search engine can provide links through which users can specify the type of content for which they are searching, an entry mechanism by which users can provide search queries, and, ultimately, search results. Within the context of the exemplary user interface 200 that is shown in FIG. 2, the links provided by the search engine are shown as the links 251 that are displayed in the content presentation area 250 and such links can, exemplarily, allow users to focus their search on images, videos, locations and the like. Similarly, the entry mechanism by which users can provide search queries as shown in exemplary user interface 200 as the search entry area 252 that is also displayed in the content presentation area 250.

In one embodiment, the search results that can be received, from a search engine, such as in response to a user's search query that can have been entered via the search entry area 252, can comprise multidimensional search results that can include, for example, content organized into pages or documents that is deemed to be responsive to the user's search, entities that are deemed to be responsive or relevant to the user search, including tasks that can be associated with those entities, and people that are deemed to be relevant to the user's search, or who can provide further information regarding the topic of the user's search. Thus, in one embodiment, each of such search result dimensions can be presented, visually, independently of one another in panes such as the panes 260, 270 and 280. As utilized herein, the term “pane” means a defined visual presentation area within which content is presented such that the content presented in a pane does not exceed the defined visual presentation area of that pane. Panes can be oriented either vertically or horizontally such that, in a vertical orientation, the horizontal boundaries of the pane are defined and such that, in a horizontal orientation, the vertical boundaries of the pane are defined. The boundaries of a pane need not be explicitly visually indicated, such as by a line or other explicit visual border, and can, instead, be implicitly visually indicated by the alignment of content within one or more panes. Similarly, the area of a pane need not be explicitly visually indicated, though, in some embodiments, to visually distinguish one pane from another, at least one pane can be presented with a shaded, colored, or black background. In such embodiments, either alternatively, or in combination with such backgrounds, the text in a pane can be white, or some other color other than the traditional textual colors, such as black.

The exemplary user interface 200 of FIG. 2 illustrates three panes for the presentation of three dimensions of search results. In one embodiment, the pane 260 can comprise content in the form of documents, such as webpages, that are deemed to be relevant to the user's search query. Colloquially, within the ubiquitous context of the World Wide Web, such a pane can be thought of as comprising the knowledge available out on the Web that is relevant to the user's search query. Similarly, in one embodiment, the pane 270 can comprise content in the form of entities, and information about such entities, which is deemed to be responsive to the user's search query, such as restaurants, hotels, retail establishments, movies, songs, artists, entertainers, and the like. Additionally, the pane 270 can comprise content in the form of tasks that can be performed with respect to such entities. For example, the pane 270 can comprise reservation tasks, such as for restaurant entities, hotel entities, rental car entities and the like, purchase tasks that can be associated with retail goods and services, and contact tasks that can be associated with retail establishment entities. Colloquially, the pane 270 can be thought of as comprising the knowledge of the search engine, specifically with respect to its understanding of entities, that is relevant to the user's search query. The pane 280, in one embodiment, can comprise content in the form of identifications of people that are deemed to be responsive to the user's search query, such as friends or other people with whom the user shares a connection such that a user is likely to trust such people, and experts or other people who represent a specialized set of knowledge that is aligned with the user's search query. The pane 280 can further comprise an indication of why such people were identified by the search engine such as, for example, by including relevant portions of information about such people or information published or shared by such people. Colloquially, the pane 280 can be thought of as comprising the knowledge of friends of the user performing the search and experts in the subject matter of the user's search.

For the sake of clarity, the descriptions below will focus on the presentation structure outlined above and shown in FIG. 2. However, the mechanisms and presentations described are not so limited. For example, while the exemplary user interface 200 of FIG. 2, and the descriptions below, are directed to embodiments where responsive documents are presented to the left of responsive entities, and responsive people are presented to the right of responsive entities, the mechanisms described are equally applicable, and provide the same advantages, irrespective of the order in which the dimensions of search results are presented. Thus, for example, any one of the responsive documents, the responsive entities, or the responsive people can be presented in a leftmost pane. Similarly, any one of the responsive documents, the responsive entities, or the responsive people can be presented in a middle or rightmost pane. Additionally, while it is contemplated that panes, such as the panes 260, 270 and 280 comprise different dimensions of search results, any one pane can comprise two or more dimensions of search results, or portions thereof, to the extent that users may be aided by such a presentation. For example, since users typically read from left to right, and since users are most used to the provision of search results in the form of responsive documents, aspects of other dimensions of search results, such as an identification of one or more responsive entities or responsive people can be previewed, or otherwise presented within the pane 260 to efficiently inform the user that their search has yielded more than merely responsive documents.

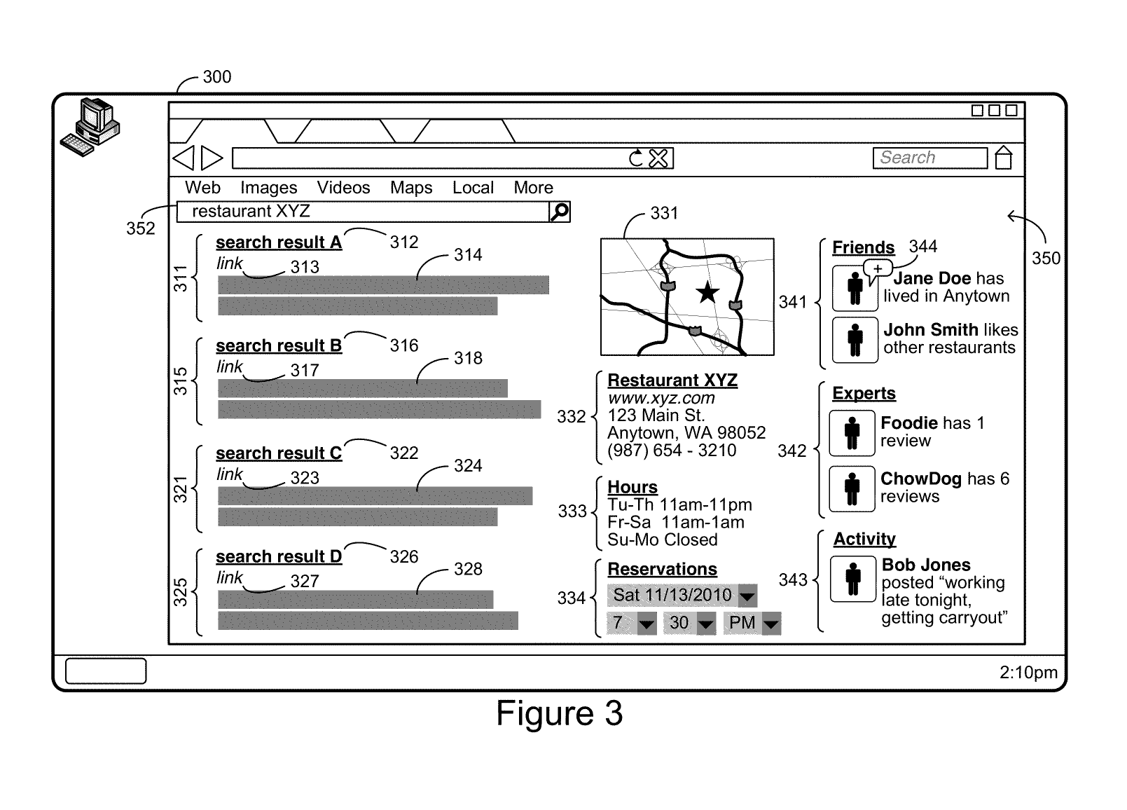

Turning to FIG. 3, the exemplary user interface 300 shown therein illustrates a specific example of multidimensional search results being provided in a multi-pane user interface. To provide a specific exemplary context, a user can have searched for a particular retail establishment such as, for example, a particular restaurant. Consequently, the search entry area 352, shown in exemplary user interface 300, is illustrated as comprising a user search query for a particular restaurant. In response to such query, the search engine can return multiple dimensions of search results. One-dimensional search results that can be returned can be an identification of documents or pages that reference the restaurant search for, or are otherwise relevant to, such a restaurant. Thus, as illustrated in the exemplary user interface 300, oriented on the left side of the content presentation area 350, can be a listing of search results 311, 315, 321 and 325. The search results 311, 315, 321 and 325 can be presented any format, though they are illustrated in the exemplary user interface 300 utilizing a common format for providing webpage search results within the context of the ubiquitous World Wide Web. Thus, for example, the search result 311 is shown as comprising an identification 312 of that search result, such as a name or title of the page or document identified, a link 313 to the page or document, and a snippet 314 comprising a small portion of the page or document, typically relevant to the user's search, that can be utilized to provide context for the user to enable the user to quickly determine whether or not the search result 311 is what the user was searching for. In a similar manner, the search result 315 is shown as comprising an identification 316, a link 317 and a snippet 318, the search result 321 is shown as comprising an identification 322, a link 323 and a snippet 324, and the search result 325 is shown as comprising an identification 326, a link 327 and a snippet 328.

As can be seen from the visual orientation of the search results 311, 315, 321 and 325 in the content presentation area 350, the search results 311, 315, 321 and 325 are being presented within a pane, although the pane is not specifically illustrated in FIG. 3, that is oriented in a vertical direction such that additional search results can be presented above or below the search results 311, 315, 321 and 325 and the user can scroll, such as in a well-known user interface manner, in such a vertical direction to view such other search results. Consequently, the boundaries of the pane in which the search results 311, 315, 321 and 325 are displayed can be oriented in a vertical manner, as is illustrated in FIG. 3 by the fact that the search results 311, 315, 321 and 325 do not extend beyond a left boundary nor do they extend beyond a right boundary that can be visually perceived, although it is not specifically indicated.

In one embodiment, such as illustrated in the exemplary user interface 300, a second pane can be oriented to the right of the pane in which the search results 311, 315, 321 and 325 are presented. Such a second pane can comprise entity and task information that can be responsive to the user's search query. For example, in the exemplary user interface 300, where a user is being provided with search results responsive to the user's search query of a particular restaurant, the restaurant the user searched for, as an entity, can be identified and entity information, such as the location of that entity, the name address and contact information for such an entity, and other like entity information, can be presented. Thus, as shown in FIG. 3, a map 331 can indicate the location of the restaurant for which the user searched. Additionally, entity identification information 332 can provide identification of the entity including, for example, the name of the entity, a network domain maintained by the entity, a physical mailing address of the entity, telephone number of the entity, and other like entity identification information.

Depending on the type of entity, other entity information can be relevant. For example, the hours of operation of retail establishment entities having physical presences can be beneficial to users. Similarly, certain types of specifications of product entities can be beneficial to users. Thus, in the exemplary user interface 300, the search engine can have provided, along with the entity identification information 332, entity operating information 333 which can include identification of the dates and times when the restaurant is open.

As indicated previously, certain types of entities may have tasks associated therewith. For example, reservation tasks can be associated with restaurant entities, hotel entities, rental car entities and the like. As another, example purchase tasks can be associated with product entities. Thus, in the exemplary user interface 300, the search engine can have provided, along with the entity identification information 332 and entity operating information 333, a reservations task 334 by which a user can make a reservation at the restaurant entity that was deemed to be responsive to the user's search query. In one embodiment, the reservations task 334 can enable a user to make a reservation without requiring the user to view additional content. In another embodiment, however, the reservations task 334 can simply ease the users' efforts at reserving a restaurant at the table, such as by providing deep links into a reservation service, or pre-filling certain information for the user with such a reservation service.

As can be seen from the visual orientation of the entity information, such as the map 331, identification information 332, operating information 333 and reservations task 334, such entity information can be presented in a pane that is separate and apart from the pane in which the search results 311, 315, 321 and 325 were presented, and is oriented to the left of the pane in which the search results 311, 315, 321 and 325 were presented. The pane comprising the entity information can, like the pane comprising the search results 311, 315, 321 and 325, be oriented in a vertical manner such that additional entity information, or additional entities, can be provided above or below the map 331, identification information 332, operating information 333 and reservations task 334. As before, a user can scroll in a vertical manner to view such other entity information. In one embodiment a user can scroll each pane individually such that, for example, a user can scroll the pane in which the search results 311, 315, 321 and 325 are presented independently of the pane presenting the entity information. The user could, thereby, view additional document search results while continuing to view the same entity information. In another embodiment, user scrolling can impact each pane equally, thereby providing user interface simplicity and avoiding clutter within the user interface. In such another embodiment, for example, the search result 311 would be aligned with the map 331 and the search result 311 and the map 331 would scroll onto and off of the presentation area 350 together.

In the exemplary user interface 300 shown in FIG. 3, the pane comprising the map 331, identification information 332, operating information 333 and reservations task 334 can be oriented in a vertical direction and, consequently, can have defined vertical boundaries on the left and the right such that entity content does not extend beyond such boundaries, as is visually illustrated in FIG. 3, although such boundaries are not explicitly illustrated. In such a manner one dimension of search results such as, for example, the document search results 311, 315, 321 and 325, can be presented independently of another dimension of search results such as, for example the entity search results which, in the present example, comprise the map 331, identification information 332, operating information 333 and reservations task 334. In the specific exemplary user interface 300 that is shown in FIG. 3, such entity search results are presented in a pane that is oriented in the center of the presentation area 350, to the right of the pane presenting the document search results, which was oriented on the left side of the presentation area 350.

Although the exemplary user interface 300 illustrates the presentation of a single entity, namely a specific restaurant, in other embodiments two or more entities can be identified in response to a user's search query. For example, if, in the exemplary user interface 300, the user had searched for a type of restaurant, such as a query for a “sushi restaurant”, rather than for the specific restaurant illustrated, entity information comprising multiple sushi restaurant entities, or other like responsive entities, could be presented to the user. Thus, for example, the map 331 could comprise location information of such multiple sushi restaurant entities. Additionally, other entity and task information about such sushi restaurant entities could be presented in a manner similar to that illustrated by the identification information 332, operating information 333 and reservations task 334. For example, each sushi restaurant entity could have identification information, operating information, reservations task, or other like information, presented in the middle pane of the exemplary user interface 300 in a serial manner such that a user could scroll down alone that middle pane to be presented with all such information. Additionally, in one embodiment, user action directed to a particular sushi restaurant entity, as indicated on the map 331, can result in a dynamic updating of the identification information, operating information and reservations task corresponding to the selected entity. For example, such identification information, operating information and reservations task could be highlighted for the user in response to user action directed to a specific entity indicated on the map 331, or it could be brought to the top, above the display of other like information for other entities, or the information for other entities could be temporarily displayed in a less prominent manner, or another like responsive presentation action could be performed.

In one embodiment, a third pane can present a third dimension of search results. For example, as illustrated by the exemplary user interface 300 shown in FIG. 3, another dimension of search results can be an identification of people relevant to the user's search query, including friends or other acquaintances of the user that may possess relevant information and experts in a field of knowledge associated with the user's search query. Thus, as illustrated by the exemplary user interface 300 of FIG. 3, one or more friends 341 can be identified in response to the user's search query. In the particular example illustrated in FIG. 3, where a user searched for a specific restaurant, the friends 341 that are identified to the user need not necessarily be individuals that the user knows that have eaten at that specific restaurant, but rather to simply be individuals whom the user knows but simply live the same town, or have otherwise expressed an interest in food related topics. As also illustrated by the exemplary user interface 300, one or more experts 342 can also be identified in response to a user's search query. Such experts can, in one embodiment, have particularized knowledge that is relevant to the user's search query. Thus, in the specific example illustrated in FIG. 3, where the user's search query was for a specific restaurant, the experts 342 that can be identified can be individuals that have eaten at that specific restaurant and who have a particularized set of knowledge or experience relevant to restaurants or dining.

In another embodiment, experts 342 need not have particularized knowledge relevant to the user's search query, but can simply be individuals considered to have expertise, or some other advanced knowledge, or knowledge not easily obtained, regarding one or more topics to which the user's search query may be relevant. For example, experts 342 need not comprise individuals that have eaten at the specific restaurant for which the user searched, but rather can be individuals who have expertise in restaurants, food preparation, dining, cuisine, and the like, irrespective of their knowledge of the specific restaurant for which the user searched. In yet another embodiment, experts 342 can be individuals whose options, insight or other intellectual product can be valued due to reasons other than their base of knowledge. For example, experts 342 can include celebrities, politicians and other famous people, irrespective of any particularized knowledge they may have regarding the user's search query. Within the context of the example illustrated in FIG. 3, in such an embodiment, the experts 342 could include a famous actor who had either authored content indicating he had eaten at the specific restaurant for which the user searched, or indicating that he liked another restaurant deemed to be related to, or associated with, the restaurant or type of restaurant for which the user searched.

In addition to an identification of people, search results can also include identification of activities performed by, or associated with, specific individuals that are relevant to the user's search query. Thus, for example, activity 343 can comprise actions performed by, or information posted by, other individuals that can be relevant to either the specific restaurant searched for by the user, or restaurant dining in general, such as, for example, the post “working late tonight, getting carryout” that is displayed as part of the activity 343 in the exemplary user interface 300.

In a manner analogous to the presentation of the task information 334, as part of the information that can be presented about one or more entities, the exemplary user interface 300 can include the presentation of mechanisms by which users can perform tasks associated with individuals listed among the friends 341, experts 342 or activity 343. Such tasks can include contacting those individuals, such as through an instant message, an electronic mail message, a computer-aided telephone call, a video chat, a posting or message posted on, or sent through, on one or more social networking services, or any other like contact mechanism. In one embodiment, such tasks can be presented to the user via a user interface element, such as the exemplary contact task user interface element 344 shown in FIG. 3. A user directing a user action to such a contact task user interface element 344 can be presented with one or more contact task options, such as those enumerated above. For ease of illustration, and to avoid illustrative clutter, only a single contact task user interface element 344 is illustrated although, as will be recognized by those skilled in the art, analogous contact task user interface elements could be part of each one of the presentations of people in the friends 341, the experts 342, or the activity 343.

As can be seen from the visual orientation of the friends 341, experts 342 and activity 343, the pane comprising such people search results can be oriented vertically, with additional people search results being able to be presented either above or below the friends 341, experts 342 and activity 343 or, conversely, extending the friends 341, experts 342 and activity 343 in the vertical direction to make room for such additional people search results. As indicated previously, a user can access such additional people search results through a scrolling user interface action which can either scroll the pane comprising such people search results independently from the above described panes, or together therewith.

In the exemplary user interface 300, shown in FIG. 3, the pane comprising the people search results can be oriented along a right side of the content presentation area 350. However, in other embodiments the panes described herein can be oriented in other vertical arrangements, including, for example, having the pane comprising the people search results on one side of the pane comprising document search results, and the pane comprising the entity search results on the opposing side of the document search results.

In another embodiment, search results can comprise at least two dimensions such as, for example, document search results and people search results. Colloquially, such search results can be based on a search concept hypothesizing that for any search query for which at least some document search results exist, there can also exist at least one individual that can possess knowledge relevant to such a search query. Turning to FIG. 4, the exemplary user interface 401 shown therein illustrates an exemplary user interface that can simultaneously present two such dimensions of search results in a multi-pane user interface. For example, as can be seen from the search entry area 411 of the exemplary user interface 401, in the specific example illustrated therein, the user can have searched for the search query “string theory”. In response, the search engine can provide document search results, such as webpages or other content that comprises the terms “string theory” or is otherwise relevant to such a concept. Such document search results can be presented as the search results 421, 422 and 423 which, as can be seen from the exemplary illustration shown in FIG. 4, can be presented within a pane that is, again, oriented in a vertical direction having defined, although not specifically illustrated, left and right vertical boundaries that the search results 421, 422 and 423 do not exceed. In the exemplary user interface 401, such a presentation pane can be oriented on the left side of the content presentation area.

The search engine can also provide people search results, such as an identification of friends 431 who have relevant educational backgrounds, and experts 432 that can comprise specialized knowledge or information specifically directed to the user's query. The provision of such people search results can be independent of whether or not the search engine has identified one or more entities relevant to the user's search query. Indeed, as indicated previously, it is contemplated that for certain search queries, document search results and people search results may be returned without any entity search results. As can be seen, in the specific example illustrated in the exemplary user interface 401, the people search results can be presented within the pane that is, like the pane presenting the document search results, oriented in a vertical direction having defined left and right vertical boundaries which, again, as previously, are not specifically illustrated in FIG. 4. Search vertical left and right boundaries can define boundaries beyond which the content of the friends 431 and the experts 432 cannot exceed to provide for clarity of presentation and avoid user confusion.

As indicated previously, the above-described exemplary user interfaces can be equally applicable within a mobile computing context, such as within the user interface as presented by tablet computing devices, smart phone computing devices and other like mobile computing devices. In one embodiment, such mobile computing devices can present similar or analogous user interfaces to those described in detail above. In another embodiment, however, the multiple panes described in detail above can be presented on separate user interface screens of such mobile computing devices such that a user can toggle between them, such as by swiping their finger across a touch-sensitive display in an appropriate direction, or otherwise performing an appropriate touch or multi-touch gesture or input. For example, as shown by the exemplary user interface 402, which can present a user interface such as would be provided by a mobile computing device, an application user interface can comprise a toolbar area 441 and a content presentation area 442. Displayed within the content presentation area 442, within the exemplary user interface 402, can be search results 461, 462 and 463 which can be analogous to the search results 421, 422 and 423 described above and illustrated in the exemplary user interface 401. More specifically, the content presentation area 442 of the exemplary user interface 402 can comprise the document search results that were presented in a single pane of the exemplary user interface 401.

In one embodiment, appropriate user action can then trigger between the exemplary user interface 402 and the exemplary user interface 403 which, as illustrated, can comprise presentation of the friends 471 and experts 472 that can be analogous to the friends 431 and experts 432 described above and illustrated in exemplary user interface 402. More specifically, the content presentation area 443 of the exemplary user interface 403 can comprise the people search results that were presented in a single pane of the exemplary user interface 401. As indicated, appropriate user action can trigger between presentation of the exemplary user interface 402 and presentation of the exemplary user interface 403. In one embodiment, such appropriate user action can be action directed to a touch sensitive display of a mobile computing device that is capable of receiving touch input from the user. For example, the user can perform a swipe 451 by touching the touch sensitive display of such a mobile computing device and then sliding their finger to one side or the other such as, for example, by touching their finger to the touch sensitive display and then sliding it to the right. Such a swipe action 451 can cause the presentation of the exemplary user interface 402 to be replaced by a presentation of the exemplary user interface 403. Similarly, analogous user action, such as the swipe 452, whereby the user touches their finger to a touch sensitive display and then slides it to the left, can stop the presentation of the exemplary user interface 403 and cause the display of the exemplary user interface 402 to be presented again. Other multi-touch gestures can be equally utilized to transition between the presentation of different dimensions of search results including, for example, multi-touch gestures based on the movement of two or more fingers in the same direction or based on touch input whereby a user brings two or more fingers together or spreads two or more fingers apart. Furthermore, in one embodiment, although not specifically illustrated in FIG. 4, visual indicators or other cues can be provided to the user such that the user is aware that other dimensions of search results can be presented as the appropriate user input is provided. As yet another example, multiple tabs could be provided such that each tab comprised one dimension of search results.

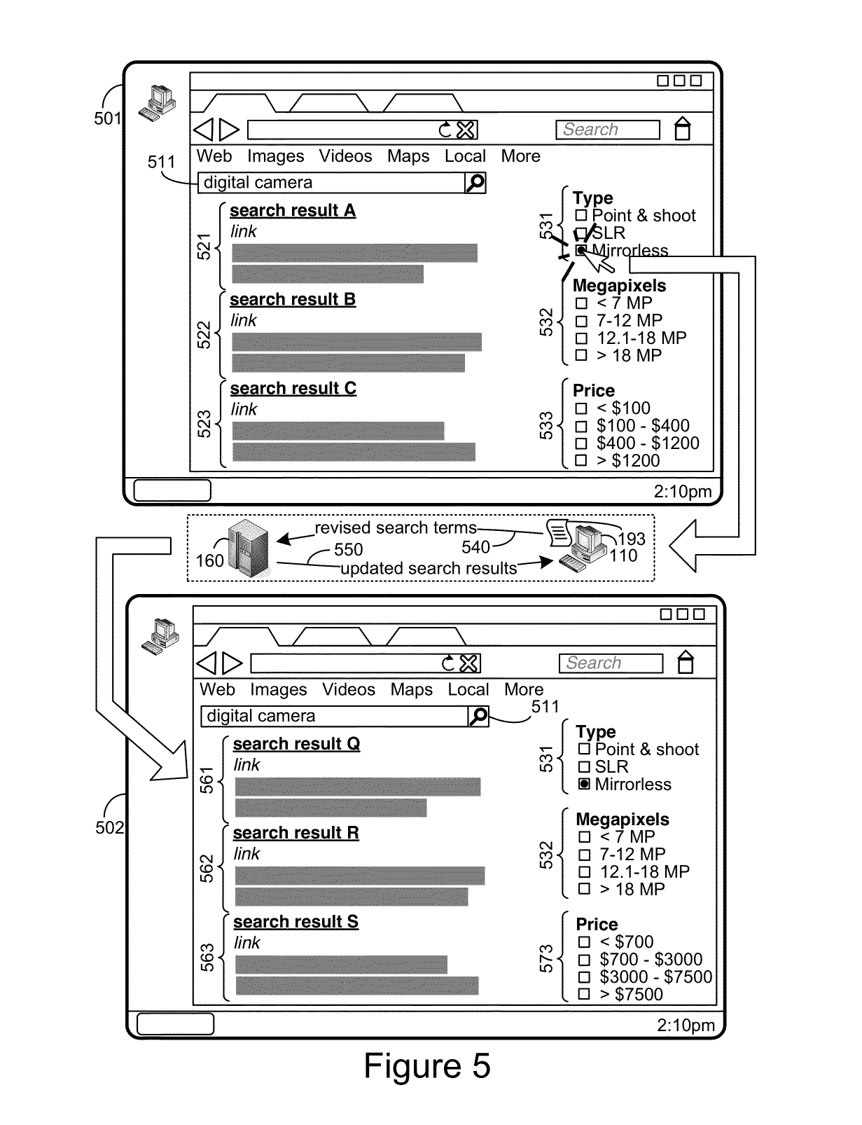

In one embodiment, user input or action directed to one dimension of search results can impact that dimension of search results, one or more of the other dimensions of search results, or combinations thereof. For example, turning to FIG. 5, the exemplary user interface 501 shown therein illustrates a multi-pane user interface presenting multiple dimensions of search results. In the specific example illustrated by the exemplary user interface 501, as can be seen by the search entry area 511, a user can search for “digital camera” or other like search query that can be perceived as being ambiguous or otherwise subject to further refinement. In one pane of the multi-pane user interface, document search results, such as the search results 521, 522 and 523 can be presented. Such search results can represent the documents, such as webpages, that the search engine perceives are most relevant to the user's search query of “digital camera”.

In another pane of the multi-pane user interface, however, entity search results can be presented to the user. In the specific example illustrated by the exemplary user interface 501, many different entities, such as different types of digital cameras, can be identified as being relevant to the user's search query of “digital camera”. Consequently, the entity search results can include entity information by which such search results can be disambiguated. Such entity information can be directed to attributes that entities, which are responsive to the user's search query, share. For example, in the example illustrated in FIG. 5, entity search results can include various attributes relevant to digital cameras, such as the entity type information 531 which can list different types of digital camera entities of which the search engine is aware, entity megapixel information 532, which can list different levels of resolution of digital camera entities of which the search engine is aware, entity price information, which can list different levels of pricing of digital camera entities of which the search engine is aware, and other like entity information. As can be seen from the exemplary user interface 501, the entity information that can be presented in the entity search result pane can be dependent upon the type of entity. For example, the entity megapixel information 532 can be entity information that is only relevant to specific types of entities such as, for example, digital camera entities. The presentation of such entity information can represent an understanding, by the search engine, of the user's search query within the context of entities such as, for example, in the present example, digital cameras.

In one embodiment, if a user were to direct user action to the entity information such user action can aid in further refining the user search and can, consequently, enable the document search results that are provided to the user, as part of another dimension of search results, to be updated to be more tailored to the type of information for which the user is searching. For example, if the user were to select from among one of the entity type information 531, such a selection can refine the type of digital camera for which the user is searching and can, consequently, result in the presentation of a different set of search results such as, for example, the search results 561, 562 and 563 that are shown as being presented as part of exemplary user interface 502. More specifically, a user selection can be recognized by a script 193, or other like computer executable instructions executing on the user's computing device such as, for example, the client computing device 110, and such a user selection can be utilized to generate revised search terms 540 that can be communicated to a search engine computing device 160, as illustrated in FIG. 5. In response, the search engine computing device 160 can return updated search results 550, which can then be displayed to the user in the exemplary user interface 502 as, for example, the search results 561, 562 and 563, which can differ from the search results 521, 522 and 523 that were previously presented to the user, such as in exemplary user interface 501.

For example, and as illustrated in FIG. 5, if a user were to select the “mirrorless” digital camera from among the entity type information 531 presented in the entity search results pane of the multi-pane user interface shown in the exemplary user interface 501, the script 193 could generate revised search terms 540 that can include not only the users search query of “digital camera” but can also include a specification that the search is to focus on “mirrorless” digital cameras. Such more specific revised search terms 540 can result in updated search results 550 that can be directed only to “mirrorless” digital cameras. Such updated search results 550 can be displayed as the document search results 561, 562 and 563. In one embodiment, the updating of one dimension of search results, such as the presentation of the updated document search results 561, 562 and 563, can occur independently of the updating of other dimensions of search results. Thus, from a user perspective, and utilizing the specific examples illustrated in FIG. 5, if a user were to select the “mirrorless” option in the entity type information 531, such an action could result in a dynamic updating of the content in another pane, such as the document search result pane, without the user perceiving that a new page had been loaded. The user could, instead, simply perceive that the document search results can be controlled by user action directed to the entity search results. In such a manner, user action directed to the entity search results can cause the document search results, or another dimension of search results, to become updated to reflect the greater specificity provided by the user's action, in a manner that is easy for the user to understand and utilize to their advantage.

In another embodiment, user action directed to the entity search results, or another dimension of search results, can cause that same dimension of search results to become updated in accordance with the user's action. Returning to the example illustrated in FIG. 5, the user's selection of “mirrorless” digital cameras from among the entity type information 531 can cause the price information 533 in the exemplary user interface 501 to change to the price information 573 in the exemplary user interface 502. Such a change can be due to differences in pricing inherent in the change from all kinds of digital cameras, as can have been the basis for the price information 533 in the exemplary user interface 501, to only “mirrorless” digital cameras, as can have been the basis for the price information 573 in the exemplary user interface 502. For example, as illustrated by the differences between the price information 533 and the price information 573, “mirrorless” digital cameras can be substantially more expensive than other types of cameras.

The above descriptions are equally applicable for disambiguating search results that are ambiguous as between different types of entities. For example, and returning to the prior example of the user whose search query is “Chicago”, the entity search results pane can comprise an identification of at least three different kinds of entities, namely the entity “Chicago” as a city in the state of Illinois, the entity “Chicago” as a musical, and the entity “Chicago” as a film. Each entity can, in one embodiment, display additional entity information relevant to the type of entity. For example, the city entity can have presented with it a map of the city of Chicago. As another example, the musical entity can have presented with it the task of purchasing tickets to a performance of Chicago. As yet another example, the movie entity can have presented with it bibliographic information, such as the names of the lead actors, the date it was released, and other like information. User action directed to one of these entities, which can be presented within an entity search results pane, can cause other dimensions of search results, such as the document search results, to be updated in accordance with the user action. Thus, for example, if the user were to interact with the map of the city of Chicago, presented within the entity search results pane, the document search results presented within the document search results pane can be updated in accordance with an updated search for “Chicago” that specifies the city of Chicago, thereby disambiguating a previously ambiguous search query.

Although the mechanisms of updating search results across one or more panes based on user action directed to a single pane have been presented within the context of examples within which the user action was directed to the entity search results, the mechanisms are not so limited. For example, the document search results can present disambiguation options, either explicitly or implicitly, and user action directed to such document search results can result in updated search results in one or more dimensions, including the document search results and the entity search results. In the above example regarding the search query “Chicago”, one document search result could be to the city of Chicago website, while another document search result could be to a web page for the musical “Chicago”. Or, alternatively, the user can be presented with an explicit disambiguation option among the document search results, for example, by directly asking the user “did you mean ‘City of Chicago, Ill.?’, or another like explicit disambiguation. In such an instance, user action directed to a specific disambiguation, or to one of the document search results, can result in an updated query being submitted and updated search results being presented. The updated search results can include updated document search results, updated entity search results, updated people search results, or any combinations thereof.

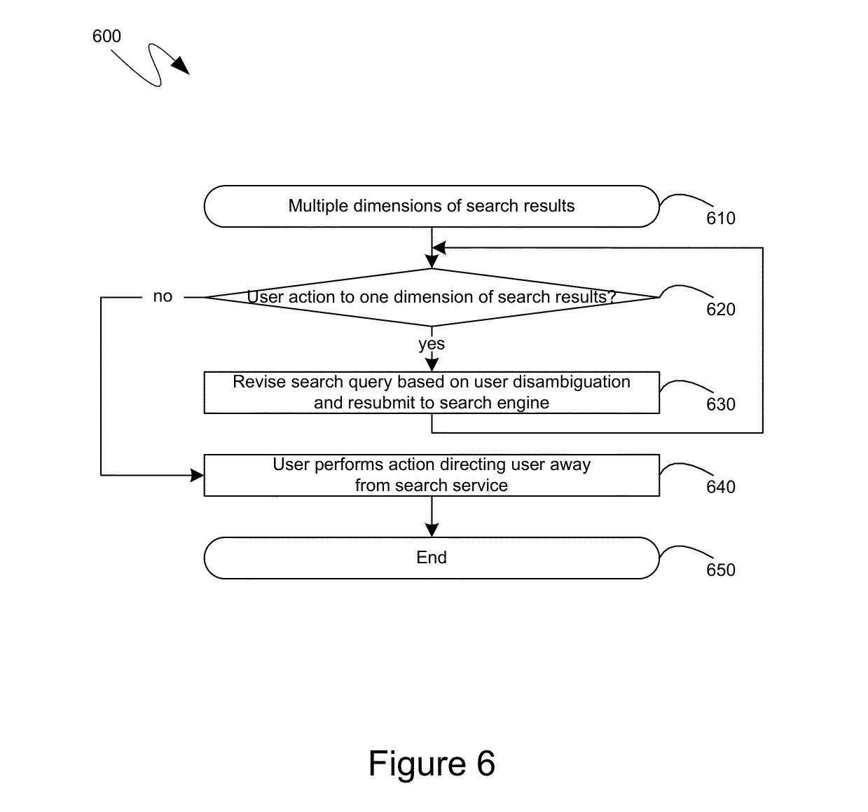

As indicated previously, in one embodiment, the updating of search results based upon user action directed to one dimension of search results can be aided by the operation of a script or other like computer-executable instructions executing on the user's computing device. Turning to FIG. 6, a flow diagram 600, illustrating an exemplary operation of such computer-executable instructions, is illustrated. Initially, as illustrated by the flow diagram 600, at step 610, multiple dimensions of search results can be received from the search engine in response to a user search query. At step 620, user action directed to one of those dimensions can be detected. For example, such as in the above examples, at step 620, user action directed to an entity, or a type of entity, can be detected. However, step 620 is not limited to user actions directed to entities. For example, returning to above example of the ambiguous user query of “Chicago”, if the user directs action to a document search result identifying the city of Chicago, then the entity search results can be updated to present only entity information and tasks associated with “Chicago” as a city entity, as opposed to, for example, as a film entity, or as a musical entity. Thus, if, at step 620, user action is detected that is directed to one dimension of search results, and thereby refines the user's search, processing can proceed to step 630 and the search query previously submitted, which resulted in the multidimensional search results received at step 610, can be revised and updated in response to the user action. Processing can then return to step 620. Alternatively, if, at step 620, no user action directed to one dimension of search results, which refines the user's search, is detected, then processing can proceed to step 640 and the user can select a link, or otherwise perform an action that causes another document or page to be obtained and presented to the user, or otherwise causes the user to be directed away from the search service that had provided the user with the multiple dimension of search results at step 610. The relevant processing can then end at step 640.

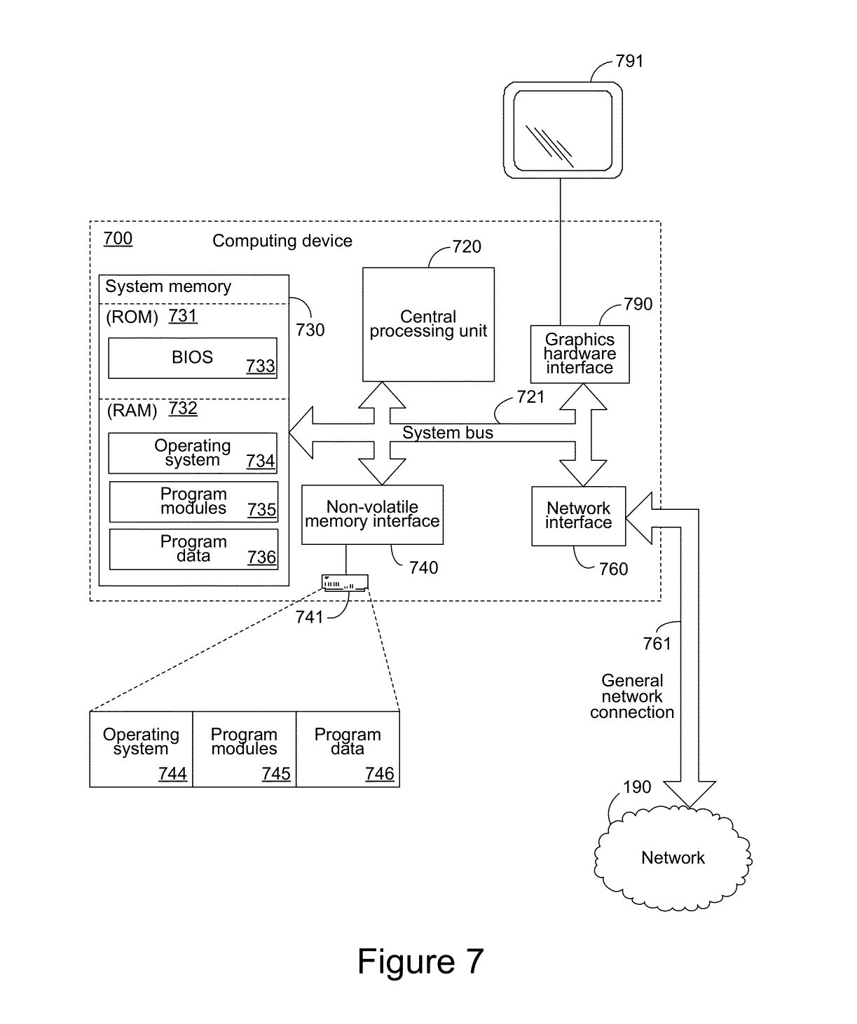

Turning to FIG. 7, an exemplary computing device 700 is illustrated. The exemplary computing device 700 can be any one or more of the computing devices illustrated in FIG. 1, whose operations were described in detail above. The exemplary computing device 700 of FIG. 7 can include, but is not limited to, one or more central processing units (CPUs) 720, a system memory 730, that can include RAM 732, and a system bus 721 that couples various system components including the system memory to the processing unit 720. The system bus 721 may be any of several types of bus structures including a memory bus or memory controller, a peripheral bus, and a local bus using any of a variety of bus architectures. The computing device 700 can optionally include graphics hardware, such as for the display of visual user interfaces, including, but not limited to, a graphics hardware interface 790 and a display device 791, which can include display devices capable of receiving touch-based user input, such as a touch-sensitive, or multi-touch capable, display device. Depending on the specific physical implementation, one or more of the CPUs 720, the system memory 730 and other components of the computing device 700 can be physically co-located, such as on a single chip. In such a case, some or all of the system bus 721 can be nothing more than silicon pathways within a single chip structure and its illustration in FIG. 7 can be nothing more than notational convenience for the purpose of illustration.

The computing device 700 also typically includes computer readable media, which can include any available media that can be accessed by computing device 700 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 700. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and the aforementioned RAM 732. A basic input/output system 733 (BIOS), containing the basic routines that help to transfer information between elements within computing device 700, such as during start-up, is typically stored in ROM 731. RAM 732 typically contains data and/or program modules that are immediately accessible to and/or presently being operated on by processing unit 720. By way of example, and not limitation, FIG. 7 illustrates the operating system 734 along with other program modules 735, and program data 736.

The computing device 700 may also include other removable/non-removable, volatile/nonvolatile computer storage media. By way of example only, FIG. 7 illustrates the hard disk drive 741 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740.

The drives and their associated computer storage media discussed above and illustrated in FIG. 7, provide storage of computer readable instructions, data structures, program modules and other data for the computing device 700. In FIG. 7, for example, hard disk drive 741 is illustrated as storing operating system 744, other program modules 745, and program data 746. Note that these components can either be the same as or different from operating system 734, other program modules 735 and program data 736. Operating system 744, other program modules 745 and program data 746 are given different numbers hereto illustrate that, at a minimum, they are different copies.

The computing device 700 can operate in a networked environment using logical connections to one or more remote computers. The computing device 700 is illustrated as being connected to the general network connection 761 through a network interface or adapter 760, which is, in turn, connected to the system bus 721. In a networked environment, program modules depicted relative to the computing device 700, or portions or peripherals thereof, may be stored in the memory of one or more other computing devices that are communicatively coupled to the computing device 700 through the general network connection 761. It will be appreciated that the network connections shown are exemplary and other means of establishing a communications link between computing devices may be used.

As can be seen from the above descriptions, mechanisms and user interfaces for presenting multidimensional search results in multiple panes have been enumerated. In view of the many possible variations of the subject matter described herein, we claim as our invention all such embodiments as may come within the scope of the following claims and equivalents thereto.

1. A method for providing multidimensional search results responsive to a user's search query via a graphical user interface physically generated on a hardware display device by a computing device, the method comprising the steps of:
receiving search results in a first dimension comprising documents identified as responsive to the user's search query;
receiving search results in a second dimension comprising entities identified as responsive to the user's search query;
receiving search results in a third dimension comprising people identified as responsive to the user's search query based upon social network content associated with those people;
generating a presentation of the first dimension of search results wholly within a first pane in a content presentation area of an information browsing application program;
generating a presentation of the second dimension of search results wholly within a second pane in the content presentation area, the second pane being arranged proximate to, but not overlapping, the first pane;
generating, in the second pane, user input elements with which a task, directed to at least one entity itself, from among the entities identified as responsive to the user's search query, can be performed;
generating a presentation of the third dimension of search results wholly within a third pane in the content presentation area, the third pane being arranged proximate to, but not overlapping, the first pane and the second pane; and
generating, in the third pane, a listing of friends separately from a listing of experts.

2. The method of claim 1, further comprising the steps of: applying a color to a background of at least two of the first pane, the second pane and the third pane such that the first pane, the second pane and the third pane are visually distinct from each other.

3-5. (canceled)

6. The method of claim 1, wherein the first, second and third panes are oriented in a vertical direction.

7. The method of claim 1, further comprising the steps of:
detecting user action directed to one dimension of search results;
updating the user's search query in accordance with the detected user action;
receiving updated search results responsive to the updated search query; and
updating the presentation of at least one of the first dimension of search results, the second dimension of search results or the third dimension of search results.

8. The method of claim 1, further comprising the steps of:
detecting user action directed to a first attribute of the entities identified as responsive to the user's search query;
updating the user's search query to focus on the first attribute;
receiving updated search results in the first dimension comprising a new set of documents identified as responsive to the updated search query;
receiving updated search results in the second dimension comprising a new set of entity information identifying attributes of entities identified as responsive to the updated user's search query share;
generating the presentation of the first dimension of search results, comprising the new set of documents, in the first pane in the place of a prior presentation of the first dimension of search results within the first pane; and
generating the presentation of the second dimension of search results, comprising the new set of entity information identifying the attributes that the entities identified as responsive to the updated user's search query share in the place of a prior presentation of the second dimension of search results within the second pane.

9. A graphical user interface system comprising a display device communicationally coupled to a computing device, the display device having generated thereon a graphical user interface providing multidimensional search results responsive to a user's search query, the user interface comprising:
a single window of an information browsing application program;
a first pane, within the single window, comprising a first dimension of search results, the first dimension of search results comprising documents identified as responsive to the user's search query;
a second pane, within the single window, being arranged proximate to, but not overlapping, the first pane, the second pane comprising a second dimension of search results, the second dimension of search results comprising entities identified as responsive to the user's search query and user input elements with which a task, directed to at least one entity itself, from among the entities identified as responsive to the user's search query, can be performed; and
a third pane, within the single window, being arranged proximate to, but not overlapping, the first pane and the second pane, the third pane comprising a third dimension of search results, the third dimension of search results comprising people identified as responsive to the user's search query based upon social network content associated with those people.

10. The graphical user interface system of claim 9, wherein at least two of the first pane, the second pane and the third pane comprise a colored background such that the first pane, the second pane and the third pane are visually distinct from each other.

11. (canceled)

12. The graphical user interface system of claim 9, wherein the third pane comprises a listing of friends separately from a listing of experts.

13. (canceled)

14. The graphical user interface system of claim 9, wherein the first, second and third panes are oriented in a vertical direction.

15. The graphical user interface system of claim 14, wherein the first pane is arranged to the left of the second pane, the second pane is arranged to the right of the first pane and the left of the third pane, and the third pane is arranged to the right of the second pane.

16. One or more computer-readable storage media comprising computer-executable instructions for providing multidimensional search results responsive to a user's search query, the computer-executable instructions directed to steps comprising:
instructing an information browsing application to display, in a first display area of a single information browsing application window, a first dimension of search results, the first dimension of search results comprising documents identified as responsive to the user's search query;
instructing the information browsing application to display, in a second display area of the single information browsing application window, different from the first display area, a second dimension of search results, the second dimension of search results comprising entities identified as responsive to the user's search query, the second display area being proximate to, but not overlapping, the first display area;
instructing the information browsing application to display, in the second display area, user input elements with which a task, directed to at least one entity itself, from among the entities identified as responsive to the user's search query, can performed;
instructing the information browsing application to display, in a third display area of the single information browsing application window, different from both the first display area and the second display area, a third dimension of search results, the third dimension of search results comprising people identified as responsive to the user's search query based upon social network content associated with those people, the third display area being proximate to, but not overlapping, the first and second display areas; and
instructing the information browsing application to display, in the third display area, a listing of friends separately from a listing of exports.

17-18. (canceled)

19. The computer-readable storage media of claim 25, wherein the computer-executable instructions are part of a script received with the multidimensional search results.

20. (canceled)

21. The method of claim 1, further comprising the steps of generating, in the second pane, a map indicating physical locations of at least some of the entities identified as responsive to the user's search query.

22. The method of claim 1, wherein the entities identified as responsive to the user's search query comprise at least one of a specific organization, a specific place, a specific product or a specific entertainment offering, the method further comprising the steps of generating, in the second pane, a presentation of metadata of the specific organization, the specific place, the specific product or the specific entertainment offering.

23. The graphical user interface system of claim 9, wherein the second pane further comprises a map indicating physical locations of at least some of the entities identified as responsive to the user's search query.

24. The graphical user interface system of claim 9, wherein the entities identified as responsive to the user's search query comprise at least one of a specific organization, a specific place, a specific product or a specific entertainment offering; and wherein further the second pane further comprises a presentation of metadata of the specific organization, the specific place, the specific product or the specific entertainment offering.

25. The computer-readable storage media of claim 16, comprising further computer-executable instructions for:
receiving a notification of a user action directed to a first item in one dimension of search results;
updating the user's search query to focus on the first item; and
instructing the information browsing application to display updated search results, the updated search results being one or more other dimensions of search results other than the one dimension of search results to which the user action was directed.

26. The computer-readable storage media of claim 16, wherein the first, second and third display areas are oriented in a vertical direction such that the first display area is arranged to the left of the second display area, the second display area is arranged to the right of the first display area and the left of the third display area, and the third display area is arranged to the right of the second display area.

27. The computer-readable storage media of claim 16, wherein the entities identified as responsive to the user's search query comprise at least one of a specific organization, a specific place, a specific product or a specific entertainment offering, the computer-readable storage media comprising further computer-executable instructions for generating, in the second display area, a presentation of metadata of the specific organization, the specific place, the specific product or the specific entertainment offering.

28. The method of claim 1, wherein the first pane, the second pane and the third pane are all generated within a same web browser application window.
